(19) United States
(12) Patent Application Publication
(10) Pub. No.: US 2009/0107211 A1
(43) Pub. Date: Apr. 30, 2009

(54) AIRFOIL SHOT PEENING TEST STRIPS

(76) Inventors: Timothy P. Hasselberg, Middletown, CT (US); Dwayne A. Braithwaite, Wallingford, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/930,262

(22) Filed: Oct. 31, 2007

(51) Int. Cl. G01N 3/34; C21D 7/06

(52) U.S. Cl. 73/11.02; 72/53

(57) ABSTRACT

A shot peening operation is developed utilizing a test strip and test strip holder. The test strip holder has an internal cavity, and the test strip lies over that cavity. Parameters of a shot peening operation can be developed utilizing the test strip, and those parameters will be acceptable for use with a part having internal cavities.

### BACKGROUND OF THE INVENTION

This application relates to a test strip for testing parameters of a shot peening operation on an airfoil, and wherein the test strip is supported on a block having a cavity to simulate a cavity within the airfoil.

Airfoils are utilized for a number of applications. Some common applications are in gas turbine engines. The airfoils may be incorporated into rotating blades, and into stationary vanes within the gas turbine engine. The gas turbine engine typically includes a compressor section having a rotor with a plurality of blades and corresponding vanes, and turbine rotors also having blades and vanes.

The blades and vanes are subject to relatively harsh environments, and thus are often made generally hollow such that cooling air can be circulated within an airfoil portion.

Also, various coatings may be utilized on these components. As an example, turbine blades may be coated with several coatings, such as a metallic bond coat, and a ceramic top coat. It is known that the bond coat needs to be prepared for the ceramic top coat to adhere properly.

One step in the known bond coat application process is a shot peening operation. The shot peening as known, may be either by gravity assisted shot peening, cut wire, ceramic bead, cast steel, glass bead, etc. The peen elements compact the bond coat and improve the overall surface finish.

Peening parameters must be developed in such a way that they will cause no damage to the parts. These parameters can then be utilized to control a peening machine for production operation.

In the prior art, test strips are known to test a particular shot peening parameter by checking peening intensity, a measure of compressive stress. However, the known test strips tend to be thin strips which are fully supported on an underlying block. As such, the developed shot peening parameters are not always appropriate for production parts having internal cavities.

### SUMMARY OF THE INVENTION

In the disclosed embodiment of this invention, a shot peening test strip is mounted on an underlying support block. The underlying support block has a cavity on a remote side of the test strip to simulate a cavity in a part. A shot peening operation can now be run on the test strip and developed parameters will be appropriate for parts to be peened in production.

These and other features of the present invention can be best understood from the following specification and drawings, the following of which is a brief description.

### BRIEF DESCRIPTION OF THE DRAWINGS

FIG. 1 shows a turbine blade.

FIG. 2 is a cross-sectional view through a portion of the turbine blade.

FIG. 3 is an exploded view of a test strip and holder.

FIG. 4 is an assembled view of the FIG. 3 components.

FIG. 5 schematically a peening operation on the test strip and block.

FIG. 6 schematically shows a production operation.

### DETAILED DESCRIPTION OF THE PREFERRED EMBODIMENT

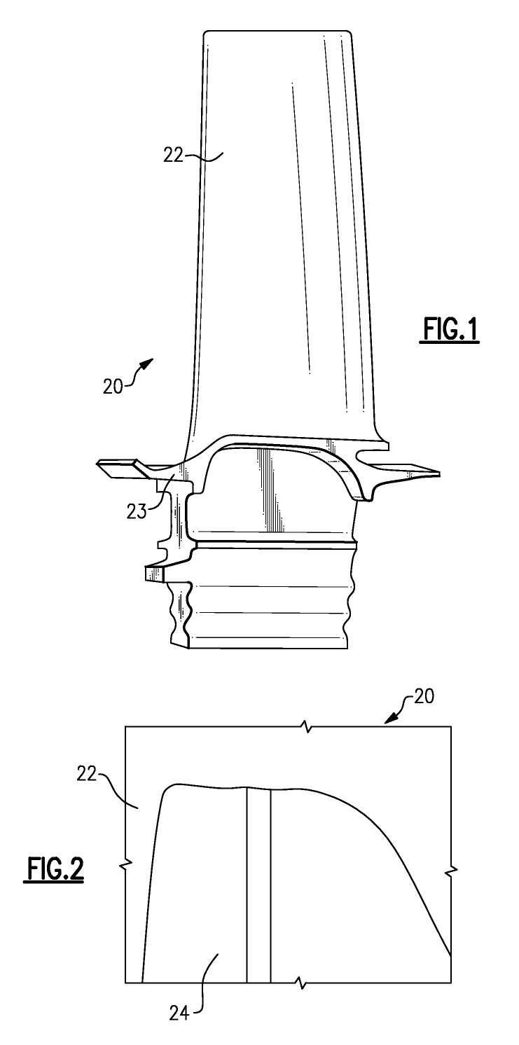

A gas turbine engine turbine blade 20 is illustrated in FIG. 1. As known, the airfoil 22 extends outwardly from a base 23.

As shown in FIG. 2, the airfoil 22 may have hollows or cavities 24. The purpose of the cavities 24 in airfoil 22 is to allow cooling air to circulate within the airfoil.

While the parts to be peened are specifically illustrated as a turbine blade, other components having an airfoil which would have internal cooling cavities, or other reasons for having cavities, may benefit from this invention.

In the past, during production shot peening operations, there has been damage to the airfoils. In part, this damage may have occurred since the testing to develop the peening operation parameters did not take into account that the airfoil will have internal cavities. Typically, the damage may be distortion, which is more likely to occur in thinner wall areas. Such damage may or may not be detected after peening. Of course, undetected damage is undesirable.

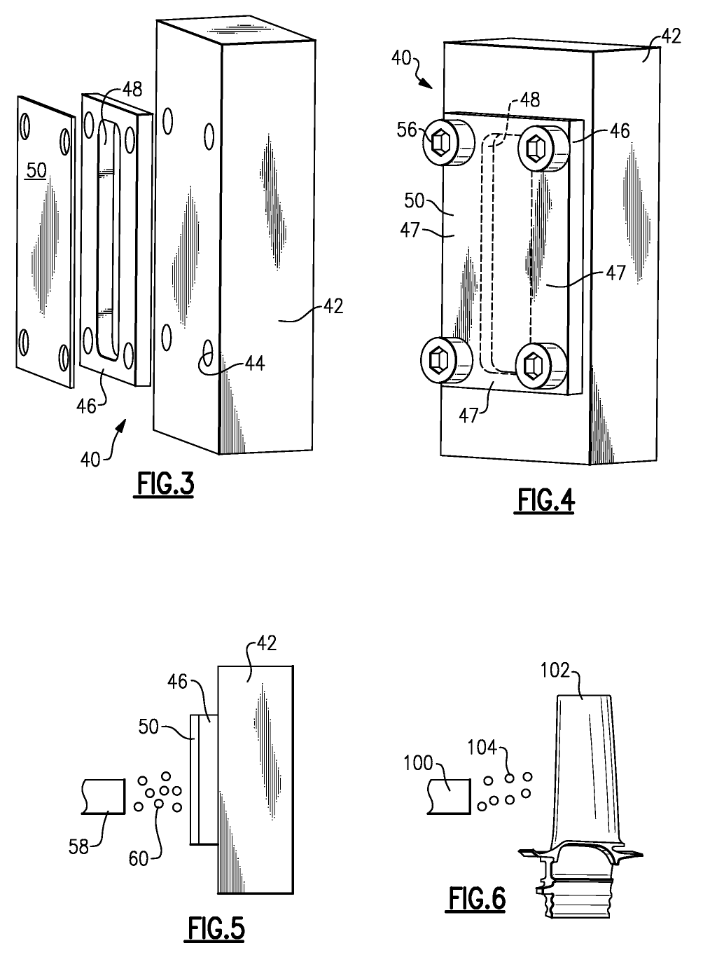

As shown in FIG. 3, a test strip and holder assembly 40 includes a solid block 42 having a plurality of bolt holes 44. A test strip holder 46 has a hollow cavity 48. The test strip 50 is mounted to the test strip holder 46, and then to the block 42. The assembled view is shown in FIG. 4. As can be appreciated from FIG. 4, the test strip has supported portions 47 surrounding the cavity 48. Now, as shown in FIG. 5, a shot peening device 58 shoots elements 60 at the test strip 50. The test strip 50 includes central portions mounted over the cavity 48. Those portions will simulate the cavity within airfoil 22. The developed parameters for the shot peening operation will now be better suited to those necessary for properly forming actual production airfoils having internal cavities.

As shown in FIG. 6, once the parameters of the shot peening operation have been developed, production shot peening can now occur. A production turbine blade 102 has a metallic bond coating applied. A shot peening device 100 is direct shot peening elements 104 at the turbine blade 120 to compact the metallic bond coat. A ceramic top coat is then applied over the compacted bond coat.

In one embodiment, the test strip holder 46 can be formed of any alloy or carbon steel. One embodiment had a test strip holder hardened to 57 hrc. This strip holder in one embodiment is ⅛ inch thick (3.2 mm), and has a 1.75 inch (44.5 mm) by 0.5 inch (12.7 mm) milled cavity 48.

The test strips can be made of any material representative of the base material of the eventual part to be shot peened. As an example, materials utilized for Pratt & Whitney gas engine turbine blades, and known as PWA1484, 1440 or 1480 may be utilized. The test strip is preferably cut to a thickness which is representative of the wall thickness of the eventual part to be shot peened.

While the invention can be utilized with any test block, one feature of this invention is that it can be easily adapted to standard SAE J442 approved Almen strip holders. This makes the invention adaptable at most peening facilities without modification of current equipment.

Of course, the test strip holder, test strip and support block may be formed of many other materials.

The airfoils are designed to have an acceptable wall thickness range or tolerance band. When developing the peening process, it is difficult to find blades that have minimum wall thickness, representing the worst case scenario. A peening process developed for blades with average wall thickness, may in fact damage blades, at the minimum wall thickness. This invention provides a method for testing a representative specimen, for any minimum thickness desired.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A test assembly for a shot peening operation comprising:
a test strip holder having a central cavity; and
at least one test strip to be attached to said test strip holder, and said at least one test strip covering said cavity, such that the combination of the said test strip mounted above said cavity simulates a part to be shot peened that has an internal cavity.

2. The assembly as set forth in claim 1, wherein said test strip surrounds said cavity on four sides.

3. The assembly as set forth in claim 1, wherein said test strip is selected to be of a material which matches the part to be shot peened.

4. A method of developing shot peening parameters for shot peening a part having an internal cavity comprising the steps of:
1) providing a test strip holder having a central cavity and mounting a test strip to said test strip holder over said cavity; and
2) directing shot peening material at said test strip, and at portions where said test strip lies over said cavity to develop shot peening parameters which will be acceptable for use in shot peening parts having an internal cavity.

5. The method as set forth in claim 4, wherein said test strips surround the cavity on four sides.

6. A method as set forth in claim 4, wherein a shot peening operation is then performed on production parts utilizing the developed parameters.

7. The method as set forth in claim 6, wherein said shot peening operation is utilized on a turbine blade after application of a bond coat, and before application of a ceramic top coat.
